(19) United States
(12) Patent Application Publication
(10) Pub. No.: US 2011/0010761 A1
(43) Pub. Date: Jan. 13, 2011

(54) CONNECTIVITY DEPENDENT APPLICATION SECURITY FOR REMOTE DEVICES

(75) Inventor: Thomas F. Doyle, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/500,563

(22) Filed: Jul. 9, 2009

(51) Int. Cl. H04L 9/32

(52) U.S. Cl. 726/5; 726/27

(57) ABSTRACT

Conditional access to security-sensitive applications and/or content in a remote device may be granted based on a history of access to connectivity (e.g., access to a communication network) for the remote device. A remote device may monitor access to connectivity. If it is determined that the remote device has a first history to access to connectivity (e.g., a recent access to connectivity), a first security level is applied in providing access to the security-sensitive application. Otherwise, if a second history of access to connectivity is ascertained (e.g., no recent access to connectivity), a second security level is applied in providing access to the security-sensitive application, where the second security level is more stringent then the first security level. If the remote device is lost, a remote server may send a request to the remote device to restrict or disable access to the security-sensitive applications and/or content

### BACKGROUND

1. Field

Various features pertain to providing conditional access to security-sensitive applications and/or content on remote devices. At least one aspect pertains to a system and method for providing a user conditional access security-sensitive applications in remote device based on the history of connectivity of the remote device.

2. Background

Access to data and services through electronic networks has become a necessary part of everyday personal and business life. Since the Internet became widely accessible, many people increasingly rely on accessing Internet data and services' through a variety of devices. Traditionally, the devices used to access networks were wired to the network, such as wired computers and wired telephones. However, busy consumers in mobile societies seek to maximize the use of their time. As a result, mobile commerce in remote devices (e.g., mobile devices, wireless communication devices, mobile phones, etc.), is rapidly growing and driving new security strategies for applications in the remote devices.

There are conflicting objectives regarding access to payment instruments in the remote devices because of tie requirements for security along with convenience. As cash replacement concepts grow in mobile commerce, security of remote devices becomes even more of a concern as mobile users begin to use their remote devices as “mobile wallets”. For example, a remote device may include an application that allows loading and storing cash or electronic cash on the remote device and using said stored cash for commercial transactions. When such remote devices are lost or stolen, the applications, including information (e.g., electronic cash) stored within the remote device can become accessible by anyone in possession the remote device. For example, anyone in possession of the remote device can access and use any electronic cash (e-cash) that is stored on the remote device to make unauthorized purchases. As e-cash is not associated with the owner or user of the mobile device, i.e. e-cash is anonymous, once the remote device is lost or stolen and the money has been used, it is not retrievable by the owner.

In some security-sensitive applications (e.g., electronic mail), the application may “timeout” after a period of non-activity and require that the user authenticate itself (e.g., provide a password) to gain access to the application. Such “timeout” scheme may provide some level of security when the device may have been left unattended. However, the “timeout” security scheme may also be inconvenient when a user may is frequently requested to provide authentication to access an application.

In view of the security risks in using a remote device and the increasing use of mobile commerce, there is a need for providing conditional access to security-sensitive applications stored in the remote device as well as the ability to disable access to those security sensitive applications to prevent unauthorized use. Consequently, a device and method are needed for allowing a user a high degree of convenience for access to security-sensitive applications stored on remote devices while concurrently providing an avenue to disable access to the security-sensitive applications.

### SUMMARY

A method and device are provided for granting conditional access to a security-sensitive application in a remote device. Access to connectivity may be used (by the remote device or an external remote server) to affect the security of the security-sensitive application. A request may be received to access a security-sensitive application in the remote device. The remote device may monitor its access to connectivity to ascertain a history of access to connectivity. If a first history of access to connectivity is ascertained, a first security level may be applied in providing access to the security-sensitive application. Otherwise, if a second history of access to connectivity is ascertained, a second security level is applied in providing access to the security-sensitive application, where the second security level is more stringent then the first security level.

In one example, the first history of access to connectivity may be indicative of a more recent access to connectivity than the second history of access to connectivity. In another example, the first history of access to connectivity may be indicative of a higher quality of connectivity than the second history of access to connectivity. Access to connectivity may also be determinative of end-to-end connectivity between the remote device and a remote server that can modify the security of the security-sensitive application. In other instances, access to connectivity may merely be a probabilistic indicator of end-to-end connectivity between the remote device and a remote server. In yet another example, the first history of access to connectivity may be indicative of a minimum threshold access to connectivity absent in the second history of access to connectivity. Consequently, the security-sensitive application may be protected from unauthorized access and is available only upon granting of access rights. Access to connectivity may permit an external or remote server to contact the remote device to restrict access to the security-sensitive application. In various examples, access to connectivity may include access to a communication network or a wireless network.

According to one feature, a security policy for the security-sensitive application may define a threshold amount of time, where the first history of access to connectivity indicates that the remote device has had access to connectivity within the threshold amount of time and the second history of access to connectivity indicates that access to connectivity has been absent for at least the threshold amount of time.

In various examples, the first security level and the second security level may be defined by a user of the remote device or by a service provider for the remote device. In one implementation, applying the first level of security may require no action by a user of the remote device to access the requested security-sensitive application. Applying the second level of security may require a user of the remote device to provide a correct authentication code to access the requested security-sensitive application. Note that, additional levels of security (beyond the first and second levels of security) may be concurrently implemented that have different triggering conditions and may require different degrees of authentication.

For instance, a plurality of different access levels may be defined for the security-sensitive application, each access level having a different security level. Each security level may have a different level of authentication to grant access to the security-sensitive application.

In one example, the security-sensitive application may be utilized anonymously without association to a user or the remote device. The security-sensitive application may include at least one of mobile financial services, health care records, electronic mail, credit history, credit card numbers, passwords, secret code numbers, automated teller machine (ATM) person identification numbers (PIN), insurance policy numbers, social security numbers, driver license numbers, or electronic cash.

The remote device may also receive a disable request from a remote server to restrict (e.g., partially restrict or completely lock out) access to the security-sensitive application. In response, the remote device may lock out access to the security-sensitive application according to the disable request.

### BRIEF DESCRIPTION OF THE DRAWINGS

The features, nature, and advantages of the present features may become more apparent from the detailed description set forth below when taken in conjunction with the drawings in which like reference characters identify correspondingly throughout.

FIG. 1 is a block diagram illustrating an example of an operating environment where a remote device may be adapted to provide conditional access to security-sensitive applications and/or content in the remote device.

FIG. 2 is a block diagram illustrating an example of a remote device configured to provide conditional access to security-sensitive applications and/or content in the remote device.

FIG. 3 illustrates a functional block diagram illustrating an example of a remote device.

FIG. 4 is a flow diagram illustrating a method operational in a remote device for defining or modifying conditions which may be used to grant, restrict, and/or deny access to security-sensitive applications and/or content in the remote device.

FIG. 5 is a flow diagram illustrating a method operational in a remote device for accessing security-sensitive applications and/or content in the remote device.

FIG. 6 (comprising FIGS. 6A and 6B) is a flow diagram illustrating a method operational in a remote device for accessing (e.g., deleting, adding, modifying or viewing) security-sensitive applications and/or content in the remote device.

FIG. 7 illustrates a method for restricting access to a security-sensitive application in a remote device based on the history of access to connectivity for the remote device.

FIG. 8 illustrates a method that may be implemented between a remote server and a remote device to restrict access to security-sensitive applications on the remote device based on access to connectivity.

### DETAILED DESCRIPTION

In the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures and techniques may be shown in detail in order not to obscure the embodiments.

### Overview

One feature provides a device and method that facilitate conditional access to security-sensitive applications and/or content in a remote device. The security-sensitive applications may include, but are not limited to, mobile financial services (e.g., e-cash), usernames and passwords, credit card numbers, bank account numbers, health care records, and/or to the confidential information, content and/or data. Access to the security-sensitive applications may be determined based on the history to access to connectivity of the remote device. For instance, the security level in granting access to security-sensitive applications and/or content in the remote device may be determined by its history of access to connectivity (e.g., the recency of access to a communication network, the length and/or quality of that connectivity, etc.). For example, if the remote device has had recent access to connectivity (e.g., within a threshold amount of time), it may utilize a first security level in providing access to a security-sensitive application. If the remote device has not had recent access to connectivity, then a second security level may be used in providing access to the security-sensitive application, where the second security level is more stringent than the first security level. For example, the first security level may allow a user of the remote device to access the security-sensitive application without the need for authenticating the user, while the second security level may require that a correct password be provided before access to the security-sensitive application is granted. Note that, additional levels of security (beyond the first and second levels of security) may be concurrently implemented that have different triggering conditions and may require different degrees of authentication. Moreover, in some cases, the same security level for different applications may have different triggering conditions (e.g., threshold times, quality of connectivity, etc.), and/or different authentication requirements (e.g., more stringent or less stringent authentication depending on application being protected). In some implementations, the type of access (e.g., read access, write access, delete/modify access) being sought by a user to a security-sensitive application may be considered in determining the security level to be applied (e.g., more stringent authentication for write access than for read access).

According to a second feature, the remote device may be adapted to allow a user to remotely restrict, modify, and/or disable access to the security-sensitive applications and/or content stored in remote device via a direct or network connectivity. For instance, if the remote device has been lost or misplaced, the user may cause a signal to be sent to the remote device (e.g., from a security server via a communication network) to disable, restrict, or modify access to the security-sensitive application(s) in the remote device. Additionally, the user may be able to send a signal to delete existing applications or content, add new applications or content, and/or modify existing applications or content. To facilitate such remote changes to the access security levels of the security-sensitive applications, a security server may be available that can communicate with the remote device (e.g., via a communication network). Thus, user may contact such security server when the remote device is lost or misplaced and cause the security server to send a message to the remote device to modify access to the security-sensitive application. Because such messaging can only be received by the remote device when it has access to connectivity, the remote device may be configured (as previously described) to automatically restrict access to the security-sensitive application if its history to access to connectivity indicates no recent access, poor quality of connectivity, or insufficient access to connectivity.

### Example Operating Environment

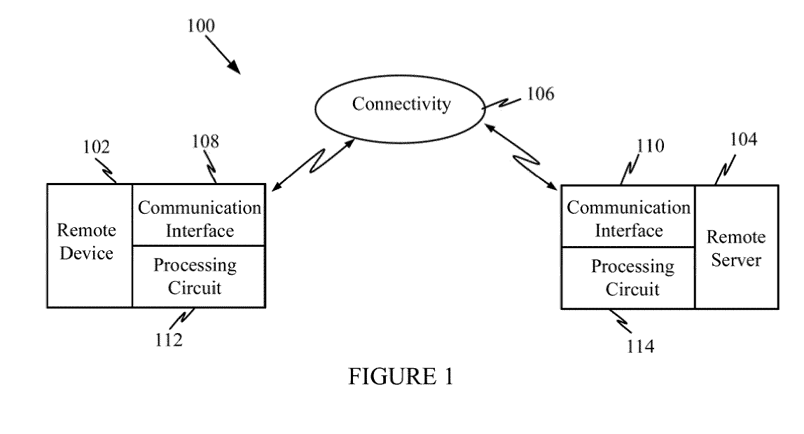

FIG. 1 is a block diagram illustrating an example of an operating environment where a remote device may be adapted to provide conditional access to security-sensitive applications and/or content in the remote device. In this system 100, connectivity 106 (e.g., a communication network) may allow communications or messaging between a remote server 104 and the remote device 102. The remote device 102 may include a communication interface 108 and a processing circuit 112. Similarly, the remote server 104 may include a communication interface 110 and a processing circuit 114.

If a user misplaces or loses the remote device 102, the user may disable or restrict access to security-sensitive applications/content in the remote device 102 by requesting that the remote server 104 send a disable/restrict message to the remote device 102. However, the remote device 102 can only receive and act on such request if it has access to connectivity 106.

To provide some degree of protection when the remote device 102 does not have access to connectivity 106, the remote device 102 may be adapted to implement a security system based on its history of access to connectivity. The remote device 102 may monitor its access to connectivity. If a request is received to access a security-sensitive application in the remote device, the history of access to connectivity for the remote device is ascertained. As employed herein, “history of access to connectivity” refers to evidence or an indicator that the remote server 104 would have been able to communicate with the remote device 102 to disable or restrict access to a security-sensitive application on the remote device 102. In general, such connectivity may refer to any information that assists the remote device 102 in determining whether it was reachable (or likely to be reachable) by the remote server 104. Consequently, ascertaining access to connectivity may be a probabilistic or a deterministic process. Such information about connectivity may be ascertained from various sources and/or communication levels (e.g., radio layer, network layer, IP layer, application layer, etc.) and may include packet counts, signal strength, whether the remote device has obtained an IP address, whether end-to-end connectivity with a remote server, etc. In one example, “history of access to connectivity” may simply refer to whether the remote device 102 has had access to a communication network through which the remote server 104 can communicate with the remote device 102. In another example, “history of access to connectivity” may refer to whether the remote device 102 was able to actually signal (or receive a signal from) the remote server 104 to verify access. Such signaling may be a ping signal (for example) that allows the remote device 102 to positively determine (based on a reply) whether it can communicate with (or is reachable by) the remote server 104 end-to-end. In another example of how connectivity may be determined or inferred, the remote device may use data traffic received by the remote device 102 as an indicator of whether adequate connectivity is available. If few or no data packets are being received, the remote device may infer a lack of connectivity. Other methods for determining connectivity may be employed and are contemplated.

Presuming that the remote device can ascertain its connectivity, it can use this information to secure its security-sensitive application according to a policy based on such connectivity. For example, if a first history of access to connectivity is ascertained, a first security level is applied in providing access to the security-sensitive application. Otherwise, if a second history of access to connectivity is ascertained, a second security level is applied in providing access to the security-sensitive application, where the second security level is more stringent then the first security level. As used herein, the term “stringent” refers to increased security such that, for example, more secure authentication may be required for the second security level than for the first security level. Various examples of secure authentication may include passwords, biometric information, etc. In one example, of such authentication may be associated with a user and/or identify such user. In another example, such authentication may be anonymous since it may be associated solely with the security-sensitive application but not necessarily a particular user.

### Remote Device

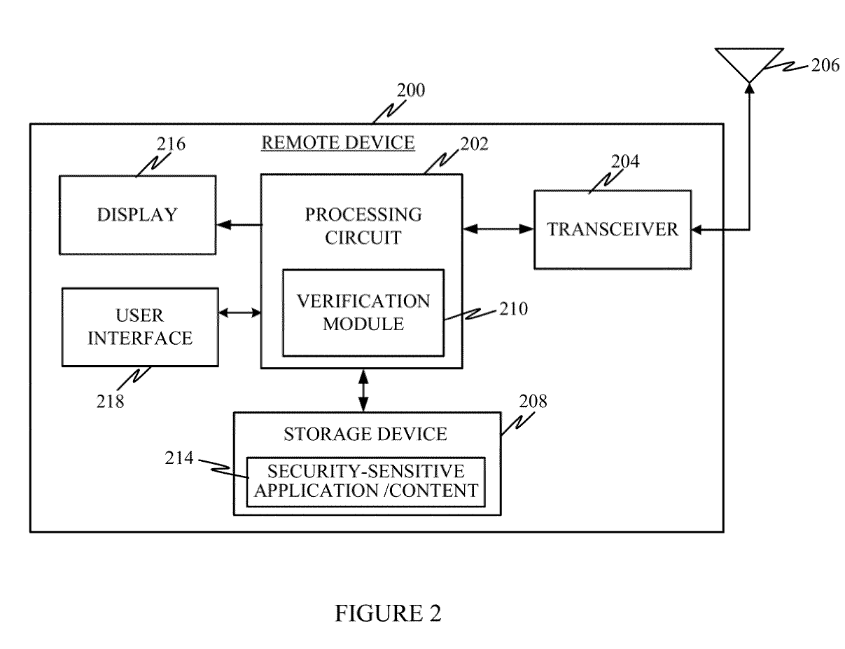

FIG. 2 is a block diagram illustrating an example of a remote device configured to provide conditional access to security-sensitive applications and/or content in the remote device 200. The remote device may operate in a system where access to connectivity is used to affect the security of the security-sensitive application. For example, access to the security-sensitive application may be externally controlled or restricted by a remote server if and/or when connectivity is available. In order to provide a measure of security in accessing the security-sensitive application when connectivity is unavailable to the remote device, the remote device may utilize connectivity information (e.g., history of connectivity to a network, quality of connectivity to the network, length of connectivity the network, etc.) to restrict access to a security-sensitive application.

Various examples of a remote device include a mobile terminal, a mobile device, a wireless communication device, a personal digital assistant, a mobile phone, cell phone, a netbook, a laptop, a computer, among other devices. The remote device 200 may include a processing circuit 202 coupled to a communication interface or a transceiver 204. In one example, the transceiver 204 may be coupled to an antenna 206 to communicate with access nodes of a wireless network. The remote device 200 may also include a storage device 208 (e.g., memory device, flash storage, etc.) to store security-sensitive applications and/or content 214. Such security-sensitive applications and/or content 214 may include, but are not limited to, mobile financial services such as banking, stored values such as e-cash, credit card numbers, usernames and passwords, health care records, and/or any other application, content or data that may benefit from implementing secure access.

The processing circuit 202 (e.g., processor, processing module, etc.) may include a verification module 210 configured to allow a user conditional access to the security-sensitive applications and/or content 214 in the remote device 200. Such conditional access may involve monitoring the connectivity (e.g., access to a wired or wireless network, etc.) of the remote device 200 to ascertain a history of access to connectivity (e.g., length of time since last access to connectivity, quality of access to connectivity, duration of access to connectivity, etc.).

According to one example, the remote device may be adapted to implement different levels of security in granting access to the security-sensitive application based on recency of access to connectivity. The verification module 210 may compare the most recent access to connectivity versus a threshold maximum amount of time. This threshold maximum amount of time may be preset by the user or a service provider. If the most recent access to connectivity for the remote device occurred more recently than the threshold maximum amount of time, then a first level of security may be applied in granting access to the security-sensitive application. Otherwise, if the most recent access to connectivity exceeds the threshold amount of time, then a second level of security may be applied in granting access to the security-sensitive application, where the second level of access is more stringent (e.g., requires stronger authentication) than the first level or security. Note that the threshold maximum amount of time may be specific or different for each stored application and/or content. In various other examples, the verification module 210 may also use quality of access to connectivity and/or duration of access to connectivity as factors in determining the level security to apply in granting access to the security-sensitive application or content 214.

In one implementation, if the remote device 200 has not had network connectivity for a maximum time threshold, then the remote device 200 may prevent access to electronic cash (or other content or applications) or may request that the user provide a security password in order to gain access to the electronic cash.

The processing circuit 202 may be configured to allow adding, deleting, and/or modifying applications and/or content in the storage device 208. The remote device 200 may also include a display 216, such as a liquid crystal display, for displaying data, such as the applications or content stored in the secure storage device 214, to a user. For example, information or the mobile financial services stored in the secure storage device may be displayed on the display 216. Upon successful confirmation by the verification module 210 of recent network coverage, access may be granted to applications in the secure storage device 214.

The remote device 200 may also include a user interface 218, coupled to the processing circuit 202, for allowing the user to input applications or content for storage in the memory device 208 or in the secure storage device 214 of the memory device 208. The user interface 218 may include, but is not limited to, a keypad and a keyboard which allow the user to provide authentication information (e.g., username, password, code, etc.) according to the security being used to grant access to the security-sensitive application. The remote device 200 may allow conditional access to the security-sensitive application 214 in the storage device 208 so as to prevent unauthorized users from accessing the application 214. Note that each security-sensitive application 214 may have its own security policy and/or access protocol defined.

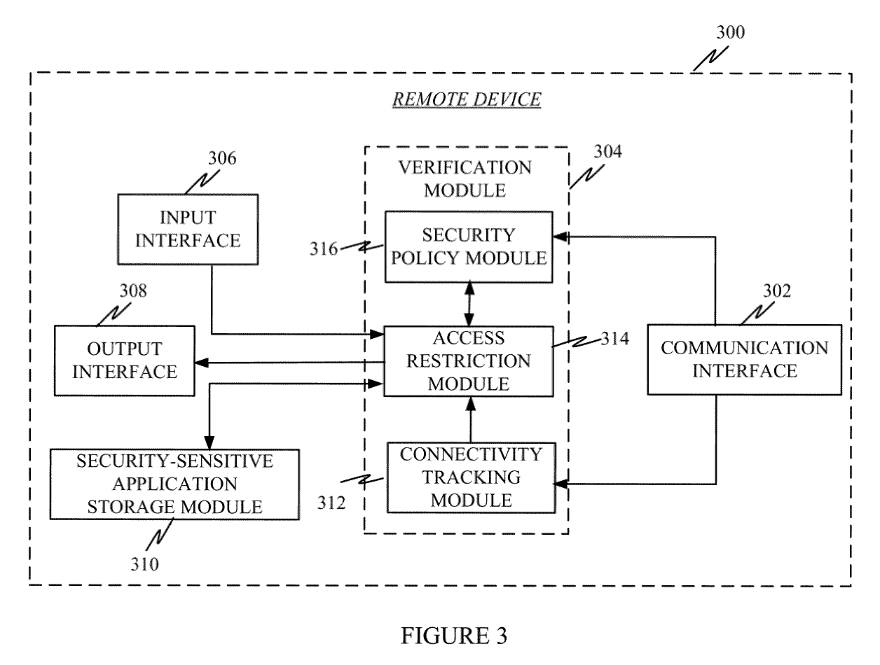

FIG. 3 illustrates a functional block diagram illustrating an example of a remote device. In this configuration, the remote device 300 may include a communication interface 302, a verification module 304, an input interface 306, an output interface 308, and/or a security-sensitive application storage module 310. The communication interface 302 may facilitate connectivity and/or access to one or more wired and/or wireless networks. The verification module 304 may include a connectivity tracking module 312, an access restriction module 314, and/or a security policy module 316.

The connectivity tracking module 312 may track or keep a history of access to connectivity via the communication interface 302. Such history of access to connectivity may track the times when the communication interface 302 indicated a communication network was available, the signal quality to that network (or access point therein), and/or the length of time of such connectivity.

The access restriction module 314 may operate according to a security policy specified by the security policy module 316 to grant, restrict, and/or deny access to the security-sensitive application storage module 310. The security policy module 316 may define rules, limits, and/or protocols that define the security policy. For example, such security policy may be defined in terms thresholds of access to connectivity (e.g., time, length, and/or quality) collected by the connectivity tracking module 312. For instance, a first security level may be applied by the access restriction module 314 in granting access to the security-sensitive application storage module 310 (or content therein) if a first history of access to connectivity is ascertained. Alternatively, a second security level may be applied by the access restriction module 314 in granting access to the security-sensitive application storage module 310 (or content therein) if a second history of access to connectivity is ascertained, where the second security level is more stringent then the first security level. Note that the security policy for a remote device may be set by the user, by an administrator for the remote device, or by a service provider.

The output interface 308 may allow the access restriction module 314 to display a security challenge to a user in order to implement security of the security-sensitivity application storage module 310. The input interface 306 may be coupled to the access restriction module 314 to allow a user to provide authentication information (e.g., username, password, security code, etc.) to the access restriction module 314 in response to the security challenge by the access restriction module 314.

If the user provides the correct authentication information to the access restriction module 314 (i.e., as specified by the security policy), then access to the security-sensitive application storage module 310 may be granted.

### Securing Applications or Content Based on Access to Connectivity History

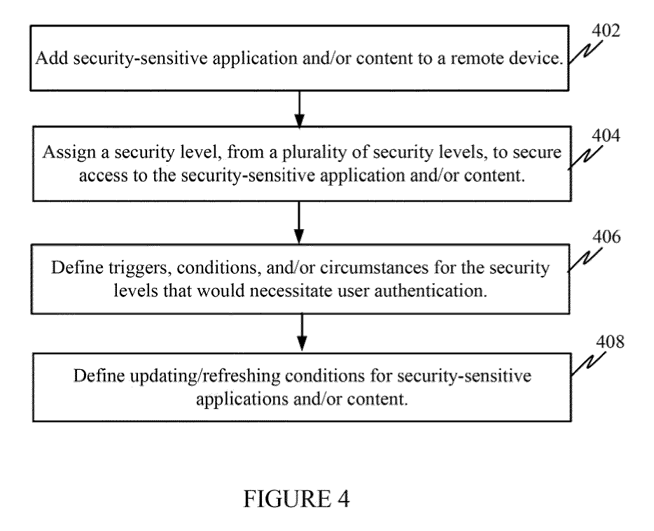

FIG. 4 is a flow diagram illustrating a method operational in a remote device for defining or modifying conditions which may be used to grant, restrict, and/or deny access to security-sensitive applications and/or content in the remote device. Initially, a user or service provider may add a security-sensitive application or content to a remote device 402. After adding the security-sensitive application or content, the user or service provider may define conditions for granting access to the security-sensitive application and/or content stored in the remote device. A security level may be assigned, from among a plurality of security levels, to the security-sensitive application or content 404, where different triggering conditions may be associated with different security level. The user or service provider may define triggers, conditions, and/or circumstances for each security level that would necessitate user authentication 406. An example of such trigger or condition may be a lack of access to connectivity for a threshold period of time. For instance, a first security level may define that after five (5) minutes of lack of access to connectivity that user authentication (or a more stringent user authentication) may be required for access to mobile banking services available through the remote device. For a second security level, a longer period of lack of access to connectivity may be required before triggering user authentication for retrieving health care records stored in the remote device. By basing the security level utilized in granting access to security-sensitive applications on the history of access (or availability) to connectivity of the remote device, the user may receive not only the benefit of convenience of using the remote device for such security-sensitive applications, but may also receive the benefit of protecting security-sensitive applications in the event the remote device is lost or stolen.

In various implementations, such triggers or conditions may be defined in terms of a time domain, such as continuous access to connectivity for a specific or pre-determined amount of minutes, hours, etc. or alternatively, a lack of continuous access to connectivity for a pre-determined amount of time. Consequently, different pre-determined time periods and a history of access to connectivity for the remote device (e.g., recency, quality and/or length of access to connectivity) may be utilized to apply a security level in granting or denying access to the security-sensitive applications in the remote device.

If it is determined that the remote device has a first history of connectivity (e.g., recent access to connectivity, good quality of signal strength, adequate duration of connectivity), a first security level is applied to authenticate a user. Meanwhile, if it is determined that the remote device has a second history of connectivity (e.g., no recent access to connectivity, poor quality of signal strength, inadequate duration of connectivity), a second security level is applied to authenticate a user, where the second security level is more stringent than the first security level. In other words, different access control techniques or authentication methods may be applied to grant, deny, and/or restrict access to security-sensitive applications and/or content depending on the history of access to connectivity for the remote device. For example, a more stringent user authentication may be implemented for one application while a less stringent user authentication may be implemented for another application. Alternatively, no user authentication may be required for some applications depending on its history of access to connectivity.

In one example, if there has been a lack of continuous or recent access to connectivity for the threshold amount of time, there may be a presumption that the user would have attempted to lock or disabled the remote device or security-sensitive applications by reporting it missing. The user may lock the remote device by telephoning the service provider or may log onto to a website that allows the user to lock or disable the remote device. Typically, a consumer or user generally knows within minutes that he/she is not in possession of a remote device. It may be presumed that the user would have taken action within a reasonable amount of time to lock or disable the remote device and/or the applications in the secure storage device. Consequently, the user may be indirectly validated or authenticated.

The user may also define if and when any of the security-sensitive applications and/or content in the remote device is to be updated or refreshed 408. For example, if e-cash stored in the remote device falls below a certain threshold or balance, the e-cash may be automatically updated or refreshed from the user's bank account. For example, $50 may be added to the remote device every time the amount of stored e-cash in the remote device falls below $10. As a result, the amount of e-cash the user may lose is never more than a specific amount.

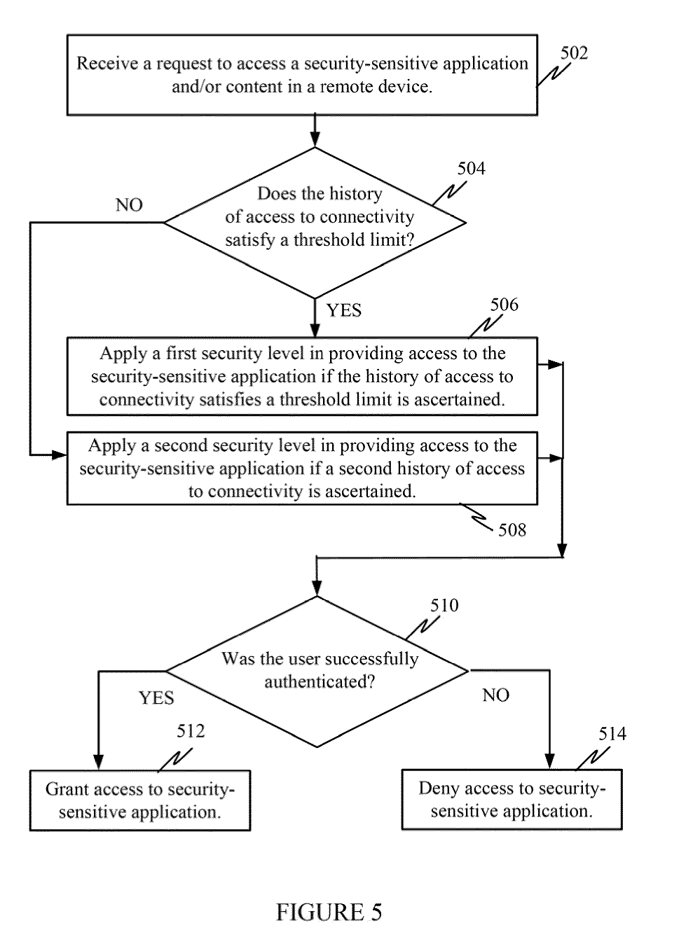

FIG. 5 is a now diagram illustrating a method operational in a remote device for accessing security-sensitive applications and/or content in the remote device. In one example, the remote device may include a secure storage device or location that may be protected from external access based on the history of access to connectivity for the remote device.

Initially, the remote device may receive a request to access security-sensitive application or content in the remote device 502. Upon receiving the request for access, the remote device may determine if its history of access to connectivity satisfy a threshold limit or condition 504. If it is determined that the remote device has a history of access to connectivity that satisfies the threshold limit or condition (e.g., a first history of access to connectivity that indicates recent access to connectivity), the remote device may apply a first level of security in providing (e.g., granting, restricting, denying) the user access to the security-sensitive application and/or content 506. As described above, security levels may be assigned by a user, or a service provider, and may be used to determine what type of authentication is applied (if any) prior to providing access to a particular security-sensitive application and/or content in the remote device. The multiple levels of security may provide varying levels of access to the security-sensitive applications and/or content. For example, a more stringent user authentication may be implemented for a first security-sensitive application while a less stringent user authentication may be implemented for a second security-sensitive application and/or content. Alternatively, no user authentication may be implemented for some applications under some conditions (e.g., recent access to connectivity). If the first level of security has been successfully verified, the user may be granted access to the secure storage device 512.

If it is determined that the history of access to connectivity does not satisfy the threshold limit (e.g., a second history of access to connectivity that indicates no recent access to connectivity), the remote device may apply a second level of security in providing (e.g., granting, restricting, denying) the user access to the security-sensitive application and/or content 508. The second security level may be more stringent than the first security level.

Upon applying the first or second security level, the remote device may determine if the user was successfully authenticated 510. This may be determined according the security policy applied by the first or second security level (e.g., was the correct password or key provided, etc.) In some implementations, such authentication may be automatically granted if recent access to connectivity is ascertained. If authentication is successful, then the user may be granted access to the security-sensitive application in the remote device 512. Otherwise, if authentication is not successful, the remote device may deny access to the security-sensitive application 514. After the user has accessed the security-sensitive application or content in the secure storage device, access may then be terminated and the application may be terminated. In one example, if the user authentication is unsuccessful, the user may be denied access and the remote device may be locked or disabled.

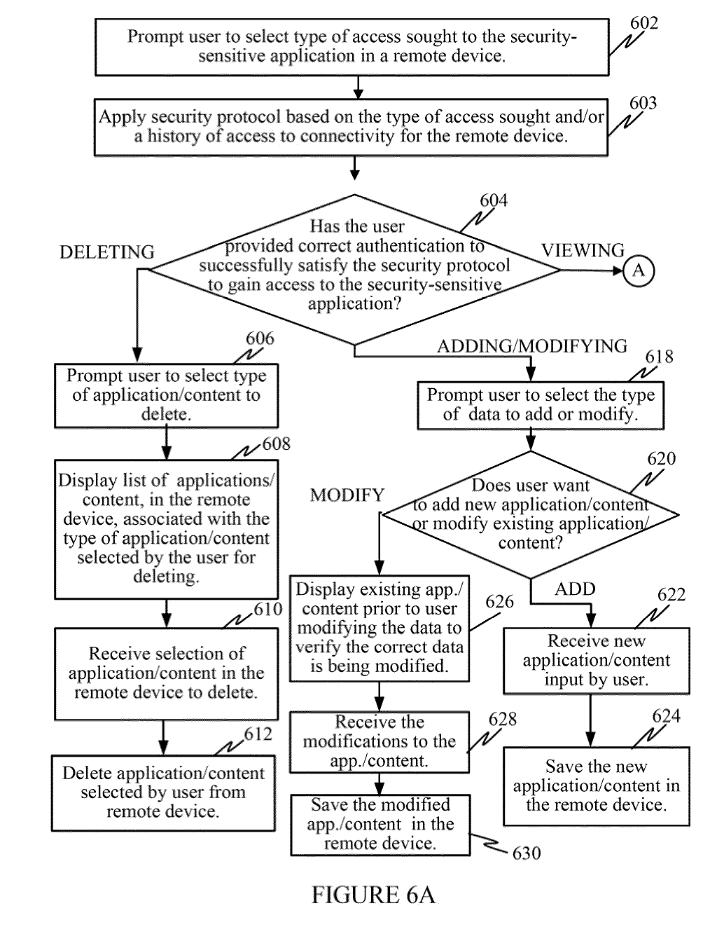

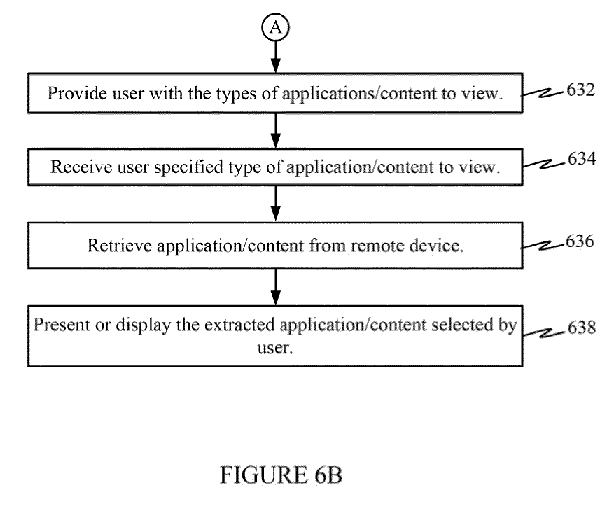

FIG. 6 (comprising FIGS. 6A and 6B) is a flow diagram illustrating a method operational in a remote device for accessing (e.g., deleting, adding, modifying or viewing) security-sensitive applications and/or content in the remote device. According to one feature, applications and/or content stored in the remote device may be protected from external access according to a security policy based on the history of access to connectivity (e.g., length of time, quality of connectivity, recency of access to connectivity, etc.) for the remote device. Additionally, the security policy may also consider the type of access being sought by a user to the security-sensitive application. For instance, depending on the user selection for access (e.g., delete, add/modify, or view access), a different level of security may be applied in granting different types of access to the security-sensitive application.

The user may be prompted to select the type of access sought to the security-sensitive application (e.g., delete an existing security-sensitive application/content, add a new security-sensitive application/content, or modify an existing security-sensitive application/content in the remote device, or view a security-sensitive application/content in the remote device) 602. The remote device may apply a security protocol based on the type of access sought and/or a history of access to connectivity for the remote device 603. For example, if no recent access to connectivity is ascertained, then a more stringent security procedure may be applied to verify that the user has authority to perform the selected operation. The remote device then determines whether the user provided the correct authentication to successfully satisfy the security protocol to gain access to the security-sensitive application/content 604. Additionally, delete access to a security-sensitive application may require a more stringent authentication than, for example, view access.

If the user has selected deleting a security-sensitive application/content in the remote device, the user may be prompted to select the type of security-sensitive application/content to delete 606. The type of security-sensitive application/content may include, but is not limited to, mobile financial services, e-cash and information such as health care records, usernames, passwords, bank accounts, insurance policy numbers, credit card numbers and the like. A list of security-sensitive applications/content in the remote device associated with the type of security-sensitive application/content selected by the user to delete may be displayed 608. From the displayed list of security-sensitive applications, the user may select the application to delete. The remote device may receive the user selection of the security-sensitive application/content to delete 610. The remote device may then delete the security-sensitive application/content selected by the user from the remote device 612.

If the user has selected adding/modifying a security-sensitive application, the user may be prompted to select the type of security-sensitive application/content to add to the remote device or existing security-sensitive application/content in the remote device to modify 618. The remote device may determine if the user wants to add a new security-sensitive application/content or modify an existing security-sensitive application/content 620. If the user wants to add a new security-sensitive application/content, the remote device may receive the new security-sensitive application/content input by the user 622 and stores or saves it in the remote device 624.

If the user wishes to modify an existing security-sensitive application/content, the remote device may display the existing security-sensitive application/content to modify prior to the user modifying the security-sensitive application/content to verify that the correct security-sensitive application is being modified 626. The remote device may receive the modifications to the security-sensitive application 628. The modified security-sensitive application may be saved in the secure storage device 630.

If the user has selected viewing a security-sensitive application/content stored in the remote device, the remote device may provide the user with the types of security-sensitive applications/content to view 632. The remote device may receive selected or specified type of security-sensitive applications/content to view 634. The security-sensitive application/content selected by the user may be retrieved from the remote device 636 and presented or displayed for a preset amount of time on a display of the remote device 638. When a preset amount of time has lapsed, the security-sensitive application/content may be cleared from the display.

### Example of Restricting Access to Content Based on Access to Connectivity History

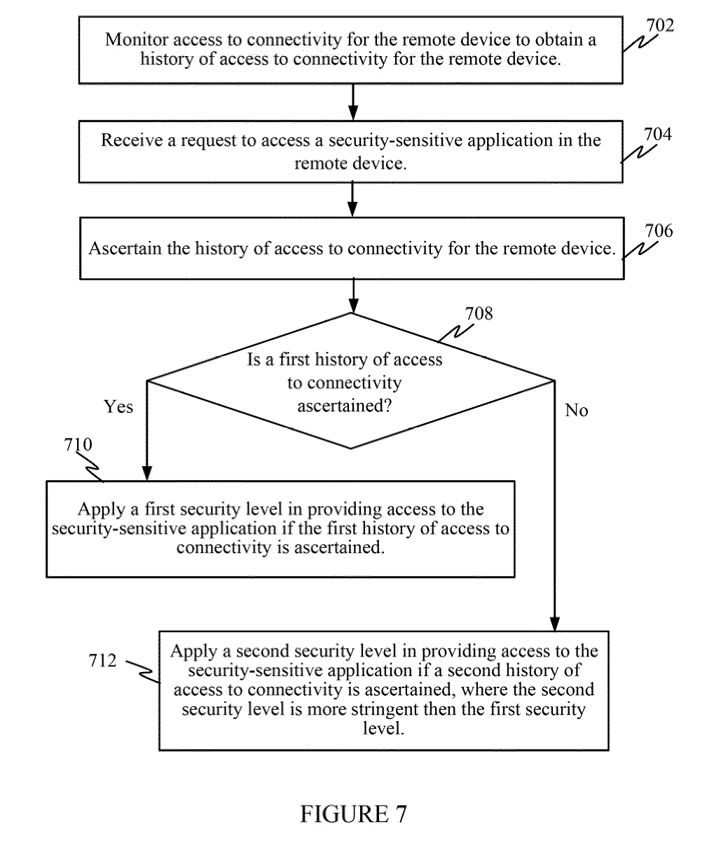

FIG. 7 illustrates a method for restricting access to a security-sensitive application in a remote device based on the history of access to connectivity for the remote device. The remote device may monitor access to connectivity to obtain a history of access to connectivity for the remote device 702. Such history of access to connectivity may indicate recency, quality, and/or length of the connectivity (e.g., to a network) for the remote device. For example, the remote device may keep a clock running that is reset every time network connectivity is detected. If the clock exceeds a threshold amount of time (i.e., no network connectivity detected for a period of time), then it may set a flag indicating no recent network connectivity.

The remote device may receive a request to access a security-sensitive application in the remote device 704. The security-sensitive application may be protected from external access and available only upon granting of access rights. The remote device may ascertain the history of access to connectivity for the remote device 706. The remote device may determine if a first history of access to connectivity is ascertained 708. If the first history of access to connectivity is ascertained, a first security level may be applied in providing access to the security-sensitive application 710. Such First history of access to connectivity may be indicative of, for example, a recent access to connectivity, a particular quality of connectivity, and/or a minimum duration of access to connectivity. Note that the level or type of access sought to the security-sensitive application may also be considered in determining which security level to apply.

Otherwise, if a second history of access to connectivity is ascertained, a second security level may be applied in providing access to the security-sensitive application, where the second security level is more stringent then the first security level 712. The first security level and the second security level may be user defined. In one example, applying the first level of security requires no action by the user to access the requested security-sensitive application. Meanwhile, applying the second level of security may require a user to enter a code or password for authentication in order to access the requested security-sensitive application.

Note that, where the difference between the first and second histories of access to connectivity is based on recency to connectivity, such recency may be defined by an amount of time since last access to connectivity of the remote device to a communication network in comparison to a threshold amount of time. The threshold amount time may be defined by the user of the remote device or defined by a service provider that provides wireless service to the remote device or that manages the requested security-sensitive application.

The security-sensitive application may include at least one of mobile financial services, health care records, credit history, credit card numbers, passwords, secret locker code numbers, automated teller machine (ATM) person identification numbers (PIN), insurance policy numbers, social security numbers, driver license numbers and electronic cash. In one example, at least one of the security-sensitive applications may be utilized anonymously without specific association to the user or the remote device.

Additionally, to the remote device may be adapted to receive a request from a remote server to disable access to the security-sensitive application. In one example, such request may be received only when the remote device has access to connectivity. Such request may be sent by the remote server, for example, when the user informs a service provider that the remote device has been lost or stolen. In response to receiving such request, the remote device may lock out access to the security-sensitive application according to the disable request.

Example of Restricting Access to e-Cash on a Wireless Communication Device

In one example, the security-sensitive application may be content or information related to electronic cash (e-cash) stored on the remote device. In this example, e-cash would be utilized like regular currency, where it can be utilized without identifying the user of the remote device in which it is stored. Additionally, once the e-cash is stored in the remote device, it may not be easily recoverable by an external application if the remote device is lost or misplaced. Consequently, when a transaction is conducted using e-cash, the anonymity of the user is preserved. A typical usage of e-cash should be easy and convenient, without necessarily requiring a user to remember passwords or codes. The user may simply enter or accept an amount to pay on the remote device, and the transaction is completed.

However, a risk exists when the remote device is lost or stolen. If no security measures are taken, the e-cash stored in the remote device may be used (i.e., illegally appropriated). In many instances, such e-cash may be utilized even when the remote device lacks network coverage. Worse yet, if the remote device is configured to replenish the e-cash every time it falls below a threshold amount (e.g., from a user's bank account or credit card), then the loss of the remote device may result in even greater losses than just the e-cash stored at the time of the loss.

Consequently, the methods previously described provide an adaptive security strategy that is aware of access to connectivity (e.g., access to network coverage) so that certain security techniques (suspend, lock, etc.) may be implemented dependent on the ability to communicate with the remote device. That is, if the remote device has current or recent access to network connectivity, it is assumed that its true owner can request that it be remotely incapacitate or disabled via the connectivity (e.g., wireless network). For example, if the remote device is lost, its true owner may request that it be disabled. Such request may be carried out via a remote network server, etc.

When the user wishes to use a security-dependent feature, such as spending electronic cash stored on the communication device, a security application on the remote device may review its history of access to connectivity. If the remote device has had consistent or recent access to connectivity, the security application may allow access to the e-cash either with no user authentication or possibly with less stringent authentication than might otherwise be employed.

The premise behind this approach is that a remote server could have communicated with the remote device and restricted access to the e-cash (or any other security-sensitive application or content) if the authorized user was not in possession of the remote device. When the security application operating on the remote device determines that the remote device has not had consistent or recent access to connectivity prior to an access request to the e-cash (or any other security-sensitive application or content), then a more stringent user authentication technique is employed. This may include any number of methods, the only expectation being that the method is more stringent than would otherwise be employed if the remote device had consistent or recent access to connectivity. Consequently, relatively easy and/or convenient access to e-cash may be maintained while the remote device has had at least a threshold access to connectivity but can be restricted when it may have been lost or stolen.

### Example of Restricting Access to Security-Sensitive Application on Remote Device

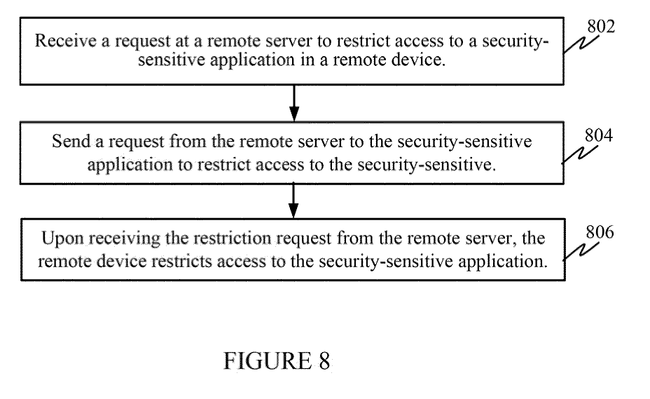

FIG. 8 illustrates a method that may be implemented between a remote server and a remote device to restrict access to security-sensitive applications on the remote device based on access to connectivity. A request may be received at a remote server to restrict access to a security-sensitive application in a remote device 802. In response to such request, a request may be sent from the remote server to the security-sensitive application to restrict access to the security-sensitive 804. Upon receiving the restriction request from the remote server, the remote device restricts access to the security-sensitive application 806.

Prior to receiving the restriction request, the remote device may monitor access to connectivity to obtain a history of access to connectivity. During this time a user request to access a security-sensitive application may be received at the remote device. A first security level may be applied by the remote device in providing access to the security-sensitive application if a first history of access to connectivity is ascertained. Otherwise, a second security level may be applied by the remote deice in providing access to the security-sensitive application if a second history of access to connectivity is ascertained, where the second security level is more stringent then the first security level.

It should be recognized that, generally, most of the processing described in this disclosure may be implemented in a similar fashion. Any of the circuit(s) or circuit sections may be implemented alone or in combination as part of an integrated circuit with one or more processors. The one or more of the circuits may be implemented on an integrated circuit, an Advance RISC Machine (ARM) processor, a digital signal processor (DSP), a general purpose processor, etc.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

One or more of the components, steps, and/or functions illustrated in the Figures, may be rearranged and/or combined into a single component, step, or function or embodied in several components, steps, or functions without affecting the operation of the pseudo-random number generation. Additional elements, components, steps, and/or functions may also be added without departing from the invention. The apparatus, devices, and/or components illustrated in the Figures may be configured to perform one or more of the methods, features, or steps described in the Figures. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention.

It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method for providing conditional access to a security-sensitive application in a remote device where access to connectivity is used to affect the security of the security-sensitive application, comprising:
receiving a request to access a security-sensitive application in the remote device;
ascertaining a history of access to connectivity for the remote device;
applying a first security level in providing access to the security-sensitive application if a first history of access to connectivity is ascertained; and
applying a second security level in providing access to the security-sensitive application if a second history of access lo connectivity is ascertained, where the second security level is more stringent then the first security level.

2. The method of claim 1, wherein the first history of access to connectivity is indicative of a more recent access to connectivity than the second history of access to connectivity.

3. The method of claim 1, wherein the first history of access to connectivity is indicative of a higher quality of connectivity than the second history of access to connectivity.

4. The method of claim 1, wherein access to connectivity is determinative of end-to-end connectivity between the remote device and a remote server that can modify the security of the security-sensitive application.

5. The method of claim 1, wherein the first history of access to connectivity is indicative of a minimum threshold access to connectivity absent in the second history of access to connectivity.

6. The method of claim 1, wherein a security policy for the security-sensitive application defines a threshold amount of time, where the first history of access to connectivity indicates that the remote device has had access to connectivity within the threshold amount of time and the second history of access to connectivity indicates that access to connectivity has been absent for at least the threshold amount of time.

7. The method of claim 1, wherein access to connectivity permits a remote server to contact the remote device to restrict access to the security-sensitive application.

8. The method of claim 1, further comprising:
monitoring access to connectivity of the remote device to obtain the history of access to connectivity for the remote device.

9. The method of claim 1, wherein a plurality of different access levels is defined for the security-sensitive application, each access level having a different security level.

10. The method of claim 1, wherein each security level has a different level of authentication to grant access to the security-sensitive application.

11. The method of claim 1, wherein the security-sensitive application.

12. The method of claim 1, wherein the second level of security requires a user of the remote device.

13. The method of claim 1, wherein the first security level and the second security level are defined by a service provider for the remote device.

14. The method of claim 1, wherein applying the first level of security requires no action by a user of the remote device to access the requested security-sensitive application.

15. The method of claim 1, wherein applying the second level of security requires a user of the remote device to provide a correct authentication code to access the requested security-sensitive application.

16. The method of claim 1, wherein the security-sensitive application is utilized anonymously without association to a user or the remote device.

17. The method of claim 1, wherein the security-sensitive application includes at least one of mobile financial services, health care records, electronic mail, credit history, credit card numbers, passwords, secret locker code numbers, automated teller machine (ATM) person identification numbers (PIN), insurance policy numbers, social security numbers, driver license numbers, or electronic cash.

18. The method of claim 1, further comprising:
receiving a disable request from a remote server to restrict access to the security-sensitive application; and
restricting access to the security-sensitive application according to the disable request.

19. The method of claim 1, wherein access to connectivity includes access to a communication network.

20. The method of claim 1, wherein the remote device is a wireless communication device.

21. A remote device adapted to provide conditional access to a security-sensitive application in the remote device where access to connectivity is used to affect the security of the security-sensitive application, the remote device comprising:
a memory device;
a transceiver coupled to the memory device, the transceiver for providing connectivity to the remote device; and
a processing circuit coupled to the memory device and the transceiver, the processing circuit configured to
receive a request to access the security-sensitive application in the remote device,
ascertain a history of access to connectivity for the remote device,
apply applying a first security level in providing access to the security-sensitive application if a first history of access to connectivity is ascertained, and
apply a second security level in providing access to the security-sensitive application if a second history of access to connectivity is ascertained, where the second security level is more stringent then the first security level.

22. The remote device of claim 21, wherein the first history of access to connectivity is indicative of a more recent access to connectivity than the second history of access to connectivity.

23. The remote device of claim 21, wherein access to connectivity permits a remote server to contact the remote device to restrict access to the security-sensitive application.

24. The remote device of claim 21, further comprising:
a verification module for monitoring access to connectivity of the remote device to obtain the history of access to connectivity for the remote device.

25. The remote device of claim 21, wherein the processing circuit is further adapted to:
receive a disable request from a remote server to restrict access to the security-sensitive application; and
restricting access to the security-sensitive application according to the disable request.

26. A remote device, comprising:
means for receiving a request to access a security-sensitive application in the remote device;
means for ascertaining a history of access to connectivity for the remote device;
means for applying a first security level in providing access to the security-sensitive application if a first history of access to connectivity is ascertained; and
means for applying a second security level in providing access to the security-sensitive application if a second history of access to connectivity is ascertained, where the second security level is more stringent then the first security level.

27. The remote device of claim 26, wherein the first history of access to connectivity is indicative of a more recent access to connectivity than the second history of access to connectivity.

28. The remote device of claim 26, further comprising:
means for monitoring access to connectivity of the remote device to obtain the history of access to connectivity for the remote device.

29. The remote device of claim 26, wherein the security-sensitive application is protected from unauthorized access and is available only upon granting of access rights.

30. The remote device of claim 26, wherein the recent network coverage is defined by an amount of time since a last access of the wireless communication device to a communication network in comparison to a threshold amount of time.

31. The remote device of claim 26, further comprising:
means for receiving a disable request from a remote server to restrict access to the security-sensitive application; and
means for restricting access to the security-sensitive application according to the disable request.

32. A circuit for providing conditional access to a security-sensitive application in a remote device, wherein the circuit is adapted to:
receive a request to access a security-sensitive application in the remote device;
ascertain a history of access to connectivity for the remote device;
apply a first security level in providing access to the security-sensitive application if a first history of access to connectivity is ascertained; and
apply a second security level in providing access to the security-sensitive application if a second history of access to connectivity is ascertained, where the second security level is more stringent then the first security level.

33. A computer-readable medium comprising instructions for providing conditional access to a security-sensitive application in a remote device, which when executed by a processor causes the processor to:
receive a request to access a security-sensitive application in the remote device;
ascertain a history of access to connectivity for the remote device;
apply a first security level in providing access to the security-sensitive application if a first history of access to connectivity is ascertained; and
apply a second security level in providing access to the security-sensitive application if a second history of access to connectivity is ascertained, where the second security level is more stringent then the first security level.

34. The computer-readable medium of claim 33, wherein the first history of access to connectivity is indicative of a more recent access to connectivity than the second history of access to connectivity.

35. The computer-readable medium of claim 33, wherein access to connectivity permits a remote server to contact the remote device to restrict access to the security-sensitive application.

36. The computer-readable medium of claim 33, comprising additional instructions which when executed by a processor causes the processor to:
monitor access to connectivity of the remote device to obtain the history of access to connectivity for the remote device.

37. A method for restricting access to a security-sensitive application on a remote device, comprising:
receiving a request at a remote server to restrict access to a security-sensitive application in a remote device;
sending a request from the remote server to the security-sensitive application to restrict access to the security-sensitive; and
upon receiving the restriction request from the remote server, the remote device restricts access to the security-sensitive application.

38. The method of claim 37, wherein prior to receiving the restriction request, the method further comprising:
monitoring access to connectivity at the remote device to obtain a history of access to connectivity;
receiving a user request to access a security-sensitive application in the remote device;
applying a first security level in providing access to the security-sensitive application if a first history of access to connectivity is ascertained; and
applying a second security level in providing access to the security-sensitive application if a second history of access to connectivity is ascertained, where the second security level is more stringent then the first security level.
